(19) United States
(12) Patent Application Publication
(10) Pub. No.: US 2025/0208928 A1
(43) Pub. Date: Jun. 26, 2025

(54) GENERATING OBSERVABILITY SIGNALS FROM EXISTING APPLICATION PROGRAMMING INTERFACES

(71) Applicant: Cisco Technology, Inc., San Jose, CA (US)

(72) Inventor: Christopher John Gascoigne, Brighton (AU)

(21) Appl. No.: 18/390,676

(22) Filed: Dec. 20, 2023

(51) Int. Cl. G06F 9/54

(52) U.S. Cl. CPC G06F 9/541; G06F 9/547

(57) ABSTRACT

In one embodiment, a device executing an agent determines, based on a configuration file for the agent, a query for particular information from a particular application programming interface from amongst a plurality of application programming interfaces in communication with the agent. The device submits, via the agent, the query for the particular information to the particular application programming interface to receive a response to the query. The device extracts, using the agent, the particular information from the response to the query, based on the configuration file. The device transforms, via the agent, the particular information into a common telemetry format for combination with telemetry regarding one or more other application programming interfaces from among the plurality of application programming interfaces.

### TECHNICAL FIELD

The present disclosure relates generally to computer systems, and, more particularly, to generating observability signals from existing application programming interfaces.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

In particular, full-stack observability (FSO) is beginning to use a technology called Open Telemetry, which is a collection of tools, application programming interfaces (APIs), and software development kits (SDKs) used to instrument, generate, collect, and export telemetry data (metrics, logs, and traces) to help analyze software performance and behavior. The observability ecosystem is rapidly converging on Open Telemetry as the standard for generation, collection and exchange of telemetry information such as metrics, logs and traces. However, there is a wealth of valuable information available in existing APIs that is not readily available to Open Telemetry-based observability solutions.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example full-stack observability platform;

FIG. 5 illustrates an example simplified system for generating observability signals from existing application programming interfaces in accordance with one or more embodiments described herein;

FIG. 6 illustrates an example observability agent in accordance with one or more embodiments described herein;

FIG. 7 illustrates an example simplified system for generating observability signals from existing application programming interfaces in accordance with one or more embodiments described herein; and

FIG. 8 illustrates an example simplified procedure for generating observability signals from existing application programming interfaces in accordance with one or more embodiments described herein.

### DESCRIPTION OF EXAMPLE EMBODIMENTS

### Overview

According to one or more embodiments of the disclosure, a device executing an agent determines, based on a configuration file for the agent, a query for particular information from a particular application programming interface from amongst a plurality of application programming interfaces in communication with the agent. The device submits, via the agent, the query for the particular information to the particular application programming interface to receive a response to the query. The device extracts, using the agent, the particular information from the response to the query, based on the configuration file. The device transforms, via the agent, the particular information into a common telemetry format for combination with telemetry regarding one or more other application programming interfaces from among the plurality of application programming interfaces.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

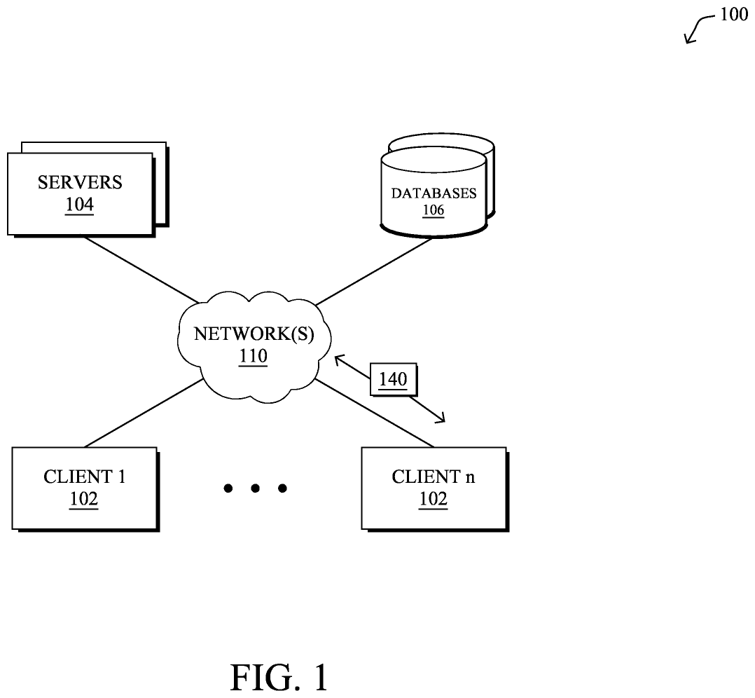

FIG. 1 is a schematic block diagram of an example computing system 100 that includes client devices 102 (e.g., a first through nth client device), servers 104, and databases 106, where the devices may be in communication with one another via network(s) 110 (e.g., any number of networks). The network(s) 110 may include, as would be appreciated, any number of specialized networking devices such as routers, switches, access points, etc., interconnected via wired and/or wireless connections. For example, client devices 102 and/or servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

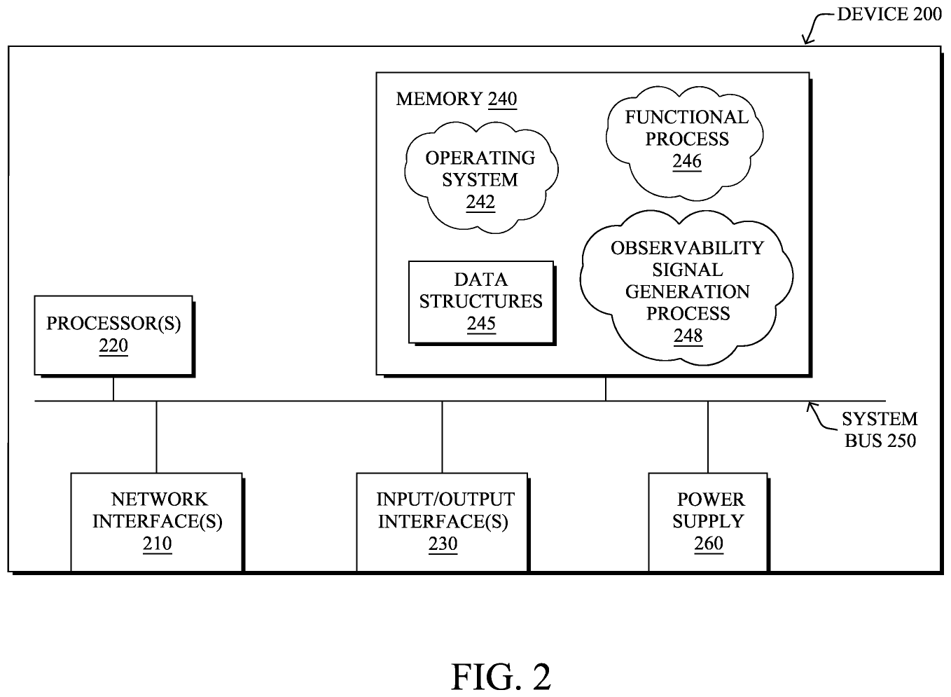

FIG. 2 is a schematic block diagram of an example node/device 200 that may be used with one or more embodiments described herein, e.g., as any of the client devices 102-106 shown in FIG. 1 above. Device 200 may comprise network interfaces 210 (e.g., one or more wired network interfaces, one or more wireless network interfaces, etc.), a processor 220, and a memory 240 interconnected by a system bus 250, as well as a power supply 260 (e.g., battery, plug-in, etc.).

The network interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “observability signal generation” process (process 248), as described herein. Notably, the one or more functional processes 246, when executed by processor 220 (or processors), cause each device 200 (e.g., a particular device or particular devices) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### ——Observability Intelligence Platform——

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

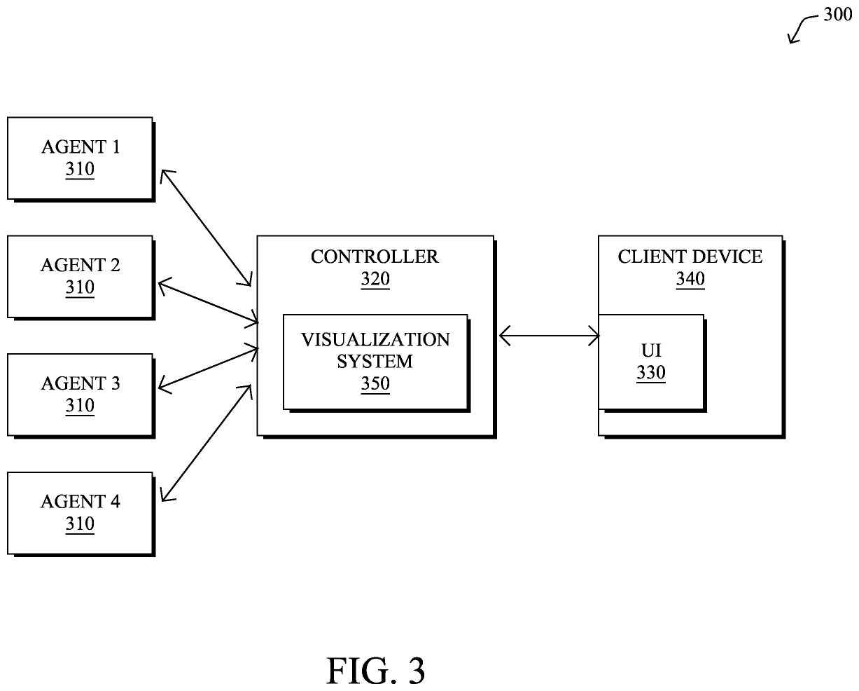

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes agents 310 (e.g., one or more agents) and one or more servers and/or controllers, such as controller 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (user interface 330, or “UI”) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the user interface 330. The user interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance may be hosted remotely by a provider of the observability intelligence platform 300. In an illustrative on-premises (On-Prem) implementation, a controller instance may be installed locally and self-administered.

The controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

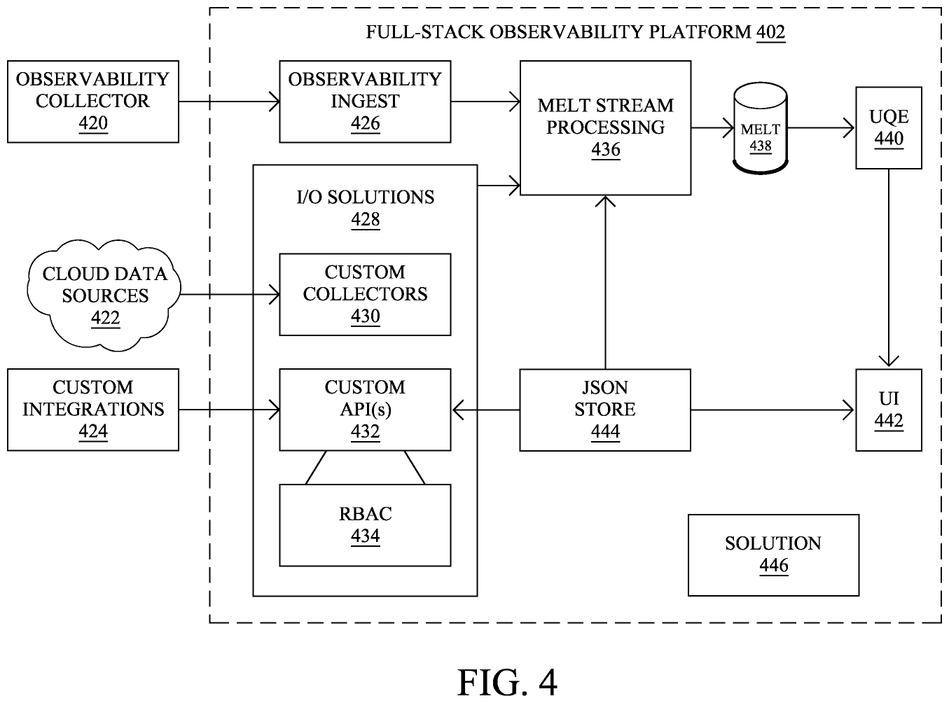

FIG. 4 illustrates an example full-stack observability platform 402. The full-stack observability platform 402 allows for observation of the real-time status of each technology stack component distributed in an IT environment. For example, the full-stack observability platform 402 can allow for a holistic view of cloud-hosted applications, services, infrastructure, on-premises servers, and/or Kubernetes infrastructure, among many other possibilities. The full-stack observability platform 402 can facilitate collection and analysis of observability data, such as Open Telemetry data, using for example, the observability collector 420, as well as collection and analysis of observability data using, for example, custom integration sources, such as the custom API(s) 432.

The observability collector 420 can be an application that collects and/or processes observability data, such as metrics, events, logs, and/or traces (which can be referred to herein as “MELT” data) and sends the observability data to various destinations within the full-stack observability platform 402. For example, as shown in FIG. 4, the observability collector 420 can send the observability data to the observability ingest 426. The observability ingest 426 can be an agent that is configured to receive the observability data from the observability collector 420 and transfers the observability data to MELT stream processing 436.

In addition, the full-stack observability platform 402 may include input/output solution, or I/O solutions 428 to collect and/or process observability data that originates at sources other than the observability collector 420. For example, observability data may come from cloud data sources 422 and/or custom integrations 424, the latter of which may include custom coded observability collectors, agents, and the like.

As used herein, the I/O solutions 428 generally refers to a collection of collectors (e.g., the custom collectors 430) and/or application programming interfaces (e.g., the custom API(s) 432). In general, the custom collectors 430 and the custom API(s) 432 are standalone applications, agents, etc. that are custom designed, coded, and built to retrieve and/or process observability data that comes from cloud data sources 422 and/or custom integrations 424. Stated alternatively, in general, the custom collectors 430 and the custom API(s) 432 are not provided as part of the Open Telemetry standard and may be manually created to facilitate collection of observability data from the custom collectors 430 and the custom API(s) 432.

One or more components of the I/O solutions 428 can include role-based security, role-based access control (RBAC), such as the RBAC 434 illustrated in FIG. 4. In general, role-based access control refers to a policy-neutral access control mechanism defined around roles and privileges. The components of RBAC such as role-permissions, user-role and role-role relationships may make it simple to perform user assignments in a computing system, such as the full-stack observability platform 402. As shown if FIG. 4, the RBAC 434 can be associated with the custom API(s) 432 to provide such role-based security, although embodiments are not so limited.

As shown in FIG. 4, the observability data received by the observability ingest 426, as well as observability data received form the I/O solutions 428 (e.g., the custom collectors 430 and the custom API(s) 432) can be sent to the MELT stream processing 436. As mentioned above, the MELT stream processing 436 can process observability MELT data (i.e., metrics, events, logs, and/or traces) received from the observability ingest 426 as well as observability data received form the I/O solutions 428 and may, as shown in FIG. 4, write the MELT data to a MELT 438 storage location, such as a datastore or other suitable memory or storage device for intermediate and/or or long-term storage of the MELT data.

The processed observability data (e.g., the data written to MELT 438) can be transferred to a query engine, such as the unified query engine (UQE 440). In some embodiments, the UQE 440 can translate information associated with the observability data from machine language to natural language, or vice versa. The UQE 440 can then fulfill a request by retrieving specific data from the MELT 438 storage location and providing the same to a user interface, such as the UI 442, for display to a user of the full-stack observability platform 402. It is noted that the UI 442 may be analogous to the user interface 330 of FIG. 3 in some embodiments.

Further, as shown in FIG. 4, the full-stack observability platform 402 can be provided with a JSON store 444. In general, the JSON store 444 can be a storage location (e.g., a database) associated with the full-stack observability platform 402 that is configured to, at minimum, store files in the JSON format. Accordingly, the JSON store 444 can be a MongoDB database, or other such similar database, although embodiments are not so limited. The JSON store 444 can be store information that can be accessible to the I/O solutions 428, the MELT stream processing 436, and/or the UI 442, among other possibilities, to facilitate operation of the full-stack observability platform 402.

Although not discussed in particular detail so as to not obfuscate implementation of the disclosure, the full-stack observability platform 402 can further include a resource to provide a solution 446. The solution 446 can be provided a visible setting to, for example, a user, and can include and/or be controlled by one or more configurable parameters, such as UI 442 access/control, RBAC 434 access/control, I/O solutions 428 access/control, object model access/control, MELT workflow access/control, health rule access/control, and/or finite mixture model access/control, and so on and so forth.

——Generating Telemetry Signals from Existing APIs——

As noted above, the observability ecosystem is rapidly converging on Open Telemetry as the standard for generation, collection, and exchange of telemetry information such as metrics, logs, and traces. However, there is a wealth of valuable information available in existing application programming interfaces (APIs) and/or software development kits (SDKs) that is not readily available to Open Telemetry-based observability solutions.

Some approaches seek to collect some of this not readily available information; however, these approaches tend to rely on extensive manual custom coding to create custom receivers, generally on an API-per-API (or SDK-per-SDK) basis. Other approaches may seek to generate custom agents to support Open Telemetry natively, by for example, using custom-built containers for each integration source (e.g., each API), but this can also require extensive manual coding. These approaches are not only expensive and time consuming, but can also require maintenance (e.g., the custom code and/or custom agents must be maintained) when APIs and/or SDKs are updated, further exacerbating the costs and time associated with these approaches.

The techniques herein, therefore, disclose a general-purpose agent that polls existing APIs and/or SDKs and generates Open Telemetry metrics from these APIs and/or SDKs. In some embodiments, the general-purpose agent of the disclosure can support many different source APIs and/or SDKs by utilizing configuration as opposed to code. This can allow for the collecting of Open Telemetry metrics from virtually any API and/or SDK without requiring customers, partners, software developers, etc. to write and maintain custom code for every API and/or SDK of interest.

Illustratively, the techniques described herein may be performed by hardware, software, and/or firmware, such as in accordance with the illustrative observability signal generation process (e.g., process 248), which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

Specifically, according to one or more embodiments described herein, a device executing an agent determines, based on a configuration file for the agent, a query for particular information from a particular application programming interface from amongst a plurality of application programming interfaces in communication with the agent. The device submits, via the agent, the query for the particular information to the particular application programming interface to receive a response to the query. The device extracts, using the agent, the particular information from the response to the query, based on the configuration file. The device transforms, via the agent, the particular information into a common telemetry format for combination with telemetry regarding one or more other application programming interfaces from among the plurality of application programming interfaces.

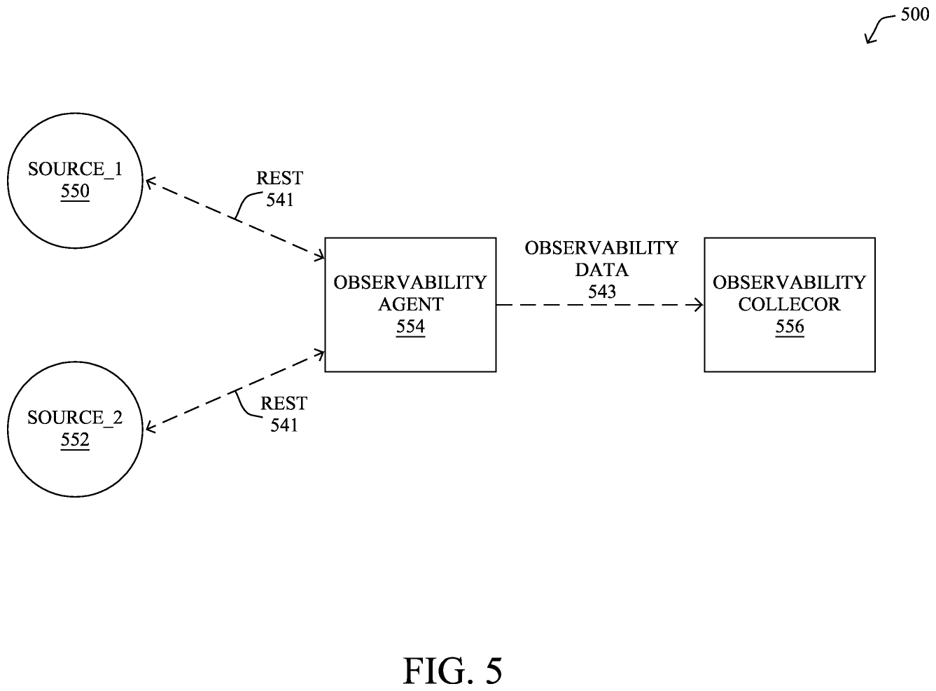

Operationally, FIG. 5 illustrates an example system 500 for generating telemetry signals from existing application programming interfaces in accordance with one or more embodiments described herein. The system 500 may be performed by one or more of the components of the full-stack observability platform 402 discussed in connection with FIG. 4.

As shown in FIG. 5, a first source 550 (“SOURCE_1”) transfers information according to the representational state transfer protocol, or REST 541 protocol, to an observability agent 554. The first source 550 can, in some embodiments, be a cloud operations platform that delivers intelligent visualization, optimization, and/or orchestration for applications and infrastructure (e.g., Cisco Intersight® or similar cloud operations platform) associated with the full-stack observability platform 402. In some embodiments, the first source 550 can include an API 551 (e.g., a REST API) to facilitate transfer of the information via the REST 541 a protocol to the observability agent 554.

The system 500 further includes a second source 552 (“SOURCE_2”) that transfers information according to REST 541 protocol to the observability agent 554. The second source 552 can, in some embodiments, be an automation platform (e.g., Cisco Nexus Dashboard® or similar automation platform) for data center network provisioning, operational management, continuous assurance, compliance checks, and/or observability data (e.g., telemetry data) associated with the full-stack observability platform 402. In some embodiments, the second source 552 can include an API 553 (e.g., a REST API) to facilitate transfer of the information via the REST 541 protocol to the observability agent 554.

Although FIG. 5 illustrates the information being transferred to the observability agent 554 according to the REST 541 protocol, embodiments are not so limited, and other protocols may be used without departing from the scope of the disclosure. One such example protocol is a remote procedure call protocol, such as the gRPC protocol. It will be appreciated that, according to the gRPC protocol, point-to-point function calls may be made over HTTP/2 as opposed to the HTTP 1.1 protocol. It will further be appreciated that other protocols besides REST and gRPC may be used in various embodiments of the disclosure.

The observability agent 554 can be configured to receive the information (e.g., telemetry information, MELT data, etc.) from the first source 550 and/or the second source 552 and provide observability data 543 to the observability collector 556. In some embodiments, the observability agent 554 is an API, although implementations are not limited to this specific architecture.

In general, the observability agent 554 is a general-purpose agent that can support a wide variety of different source APIs and can therefore receive information from many different types of source APIs. As described in more detail herein, the observability agent 554 supports these different types of APIs through configuration as opposed to code. The observability agent 554 can poll the source APIs, such as the API 551 and/or the API 553 (e.g., APIs associated with the first source 550, the second source 552, and/or other source APIs that are communication with the system 500) to request information, such as observability information, telemetry data, MELT data, etc.

Once the observability agent 554 receives this information from the source APIs, the observability agent 554 can generate observability data 543, such as Open Telemetry metrics, among other observability data, from the information received from the source APIs. As shown in FIG. 5, the observability agent 554 can then send the observability data 543 to an observability collector 556. In some embodiments, the observability collector 556 can be analogous to the observability collector 420 illustrated in FIG. 4, although implementations are not so limited.

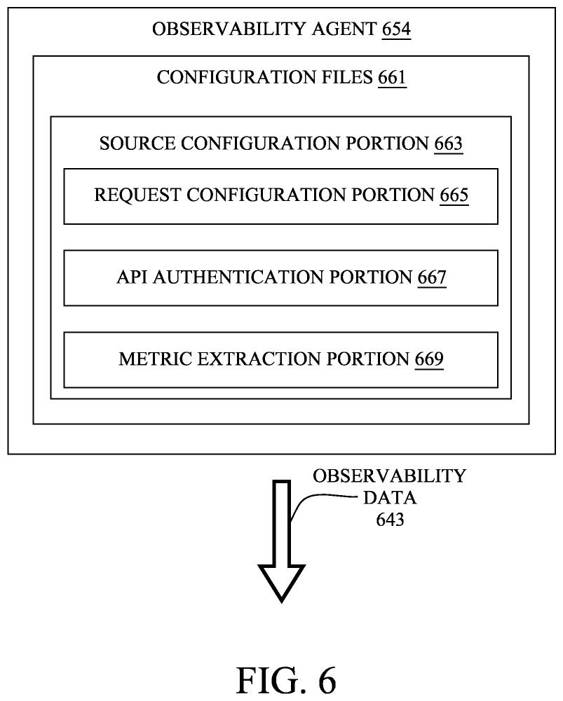

The observability agent 554 can be provided with various configurations (e.g., the configuration file(s) 661 of FIG. 6), as opposed to computer code, as part of polling the source APIs for the information. In some embodiments, the observability agent 554 can be provided with configuration files that include a source configuration portion (e.g., the source configuration portion 663 of FIG. 6) that define multiple source APIs where a particular configuration file that corresponds to each source API is provided. In general, each of the source APIs and/or source(s), such as the first source 550, the second source 552, etc. can be defined within the configuration file(s) 661 according to a name corresponding to the source and/or a polling time associated with a polling interval at which the query the source(s).

The source configuration portion 663 can further include a request configuration portion (e.g., the request configuration portion 665 of FIG. 6) that can specify a data transfer protocol and/or scheme, such as HTTP, HTTPS, HTTP/2, etc. In addition, the request configuration portion 665 of the source configuration portion 663 can include information associated with a host (e.g., a computing system hosting an application, API, etc.), a port (e.g., a port associated with a computing system hosting an application, API, etc.), a request path, a request query, a request method (e.g., GET, POST, PATCH, DELETE, etc.), among other fields that may be supplied to the request configuration portion 665.

The source configuration portion 663 can further include an API authentication portion (e.g., the API authentication portion 667 of FIG. 6) that can specify an authentication scheme (e.g., basic/bearer token authentication schemes, HTTP signature authentication schemes, OAuth2 authentication schemes, etc.), an authentication configuration (e.g., a username/password authentication scheme, an authentication token scheme, an OAuth2 authentication scheme, a client_ID authentication scheme, a client_secret authentication scheme, etc.).

The source configuration portion 663 can further include a metric extraction portion (e.g., the metric extraction portion 669 of FIG. 6) that can specify a selected metric extractor module (e.g., a JSONPath extractor module, an XPath extractor module, a regular expression extractor module, etc.), an extractor configuration (e.g., JSONPath query(s) extractor configurations, XPath query(s) extractor configuration, etc.), and so on and so forth.

FIG. 6 illustrates an example observability agent 654 in accordance with one or more embodiments described herein. The observability agent 654 may be analogous to the observability agent 554 discussed in connection with FIG. 5, above. In contrast to some approaches, which generally rely on custom developed agents and/or manual coding to collect observability data from multiple API sources, the observability agent 654 is a general-purpose agent that utilizes configuration file(s) 661 to communicate with any known or to be developed API, interface (e.g., the first source 550 of FIG. 5), dashboard (e.g., the second source 552 of FIG. 5), etc. In addition, it is noted that the observability agent 654 can be modular so that additional protocols (e.g., gRPC), authentication schemes (e.g., client certificate) and/or extractor modules (e.g., Go template) can be added to expand the functionality of the observability agent 654.

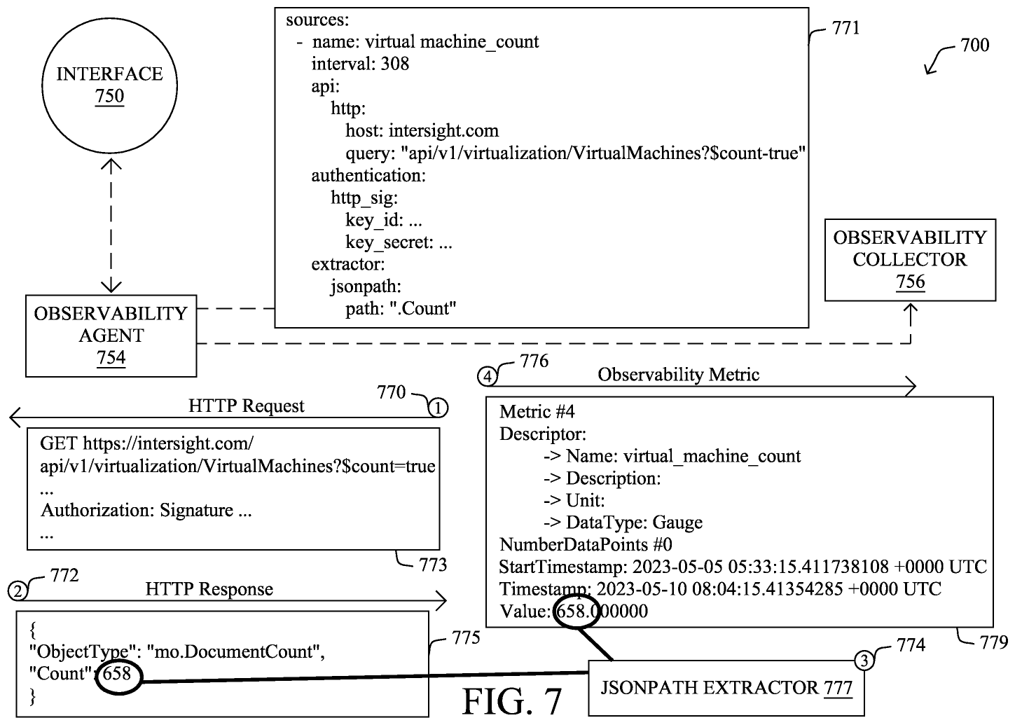

As discussed above, the observability agent 654 can receive and/or process configuration file(s) 661. These configuration file(s) 661 can utilize multiple fields in which “snippets” can be added to the configuration file(s) 661, as discussed herein. For example, as shown in FIG. 6, the observability agent 654 can operate using multiple “snippets” that can be part of the configuration file(s) 661 and can be referred to herein in the alternative as “portions” of the configuration file(s) 661. As used herein, a “snippet” generally refers to a “configuration snippet,” such as the configuration snippet 771 of FIG. 7, that is used to additional configuration(s) to the configuration file(s) 661. As shown in FIG. 6, the fields of the configuration file(s) 661 or configuration snippet can include a source configuration portion 663, which can further include a request configuration portion 665, an API authentication portion 667, and/or a metric extraction portion 669, all of which are discussed in more detail above in connection with FIG. 5 and/or below in connection with FIG. 7.

As discussed above in connection with FIG. 5, the observability agent 654 can process the information received from the various source(s) and output observability data, such as the observability data 643. The observability data 643 can be analogous to the observability data 543 of FIG. 5 and, accordingly, can be sent to an observability collector, such as the observability collector 556 of FIG. 5.

FIG. 7 illustrates an example system 700 for generating observability signals from existing application programming interfaces in accordance with one or more embodiments described herein. The example system 700 of FIG. 7 may be analogous to at least a portion of the full-stack observability platform 402 of FIG. 4 and/or at least a portion of the system 500 illustrated in FIG. 5, herein. In the non-limiting example shown in FIG. 7, the observability agent 754 (which can be analogous to the observability agent 654 of FIG. 6) is operating with a single API source in the configuration snippet. It will be appreciated that the example of FIG. 7 is shown using only one API source for simplicity in explanation of the disclosure; however, it will also be appreciated that the system 700 can be scaled readily to handle multiple API sources in a similar manner to the non-limiting example of FIG. 7.

In the example of FIG. 7, a configuration snippet 771 is provided to the observability agent 754. The configuration snippet 771 includes a source configuration portion (which can be analogous to the source configuration portion 663), a request configuration portion (which can be analogous to the request configuration portion 665), an API authentication portion (which can be analogous to the API authentication portion 667), and a metric extraction portion (which can be analogous to the metric extraction portion 669).

For example, the source configuration portion comprises the portion of the configuration snippet 771 that reads:

```
sources:
- name: virtual_machine_count;
  interval: -300-;
  api:
    http:
        host: intersight.com
      query: “api/v1/virtualization/VirtualMachines?$count=true”
```

The API authentication portion comprises the portion of the configuration snippet 771 that reads:

```
authentication:
  http_sig:
  key_id: ...
  key_secret: ...
```

The metric extraction portion comprises the portion of the configuration snippet 771 that reads:

```
extractor:
  jsonpath:
    path: “.Count”
```

In response to execution of the configuration snippet 771, the observability agent 754 will poll a source (e.g., an API source, as described above in connection with FIG. 5 and FIG. 6 and as defined in the configuration snippet 771) according to a polling interval that is defined in the configuration snippet 771. In this particular example, where the polling interval is defined in the configuration snippet 771 as three hundred seconds (300 seconds), the observability agent 754 will poll the API source every three hundred seconds. It will be appreciated, however, that embodiments are not limited to this particular enumerated polling interval and polling intervals that are greater than three hundred seconds or less than three hundred seconds are contemplated by the disclosure and are easily configurable by altering the language included in the configuration snippet 771.

At each polling interval in the example shown in FIG. 7, the observability agent 754 can create an HTTP GET request as defined in the source configuration portion of the configuration snippet 771, and as illustrated at the first operation 770. In the particular example of FIG. 7, the HTTP GET request can be sent to https://intersight.com/api/v1/virtualization/VirtualMachines?$count=true, as shown at block 773, although embodiments are not limited to this particular illustrative URL. In addition, utilization of the HTTP protocol and/or the GET request are merely provided to illustrate the example of FIG. 7 and, accordingly, other protocols and/or request types may be used without departing from the scope of the disclosure.

The request (e.g., the GET request in this example) can be authenticated using the HTTP signatures authentication scheme, by adding an Authorization: Signature <signature> header and generating the signature using the configured key_id and key_secret, as shown at block 773. It will be appreciated, however, that alternate authentication schemes may be used depending on the authorization type included in the configuration snippet 771.

As illustrated in FIG. 7, the HTTP GET request at the first operation 770 and/or the authentication information shown at block 773 are transferred to an interface 750. The interface 750 can be analogous to the first source 550 of FIG. 5 and/or the second source 552 of FIG. 5. Once the interface 750 receives and processes the request at the first operation 770 and/or the authentication information shown at block 773, the interface 750 can return an HTTP response as shown at the second operation 772. In some embodiments, the example HTTP response shown in FIG. 7 can include the information shown at block 775.

Continuing with this non-limiting example, at a third operation 774, a JSONPath extractor 777, as defined in the configuration snippet 771, process the response from the interface 750 by applying a JSONPath filter .Count to the response. The JSONPath extractor 777 can then emit observability data (e.g., telemetry data, MELT data, etc.) extracted from the response with the configured name (virtual_machine_count in this example, as defined in the configuration snippet 771) and/or an extracted value as shown in block 779. The observability data and/or the extracted value from block 779 may then be transferred at a fourth operation 776 to the observability collector.

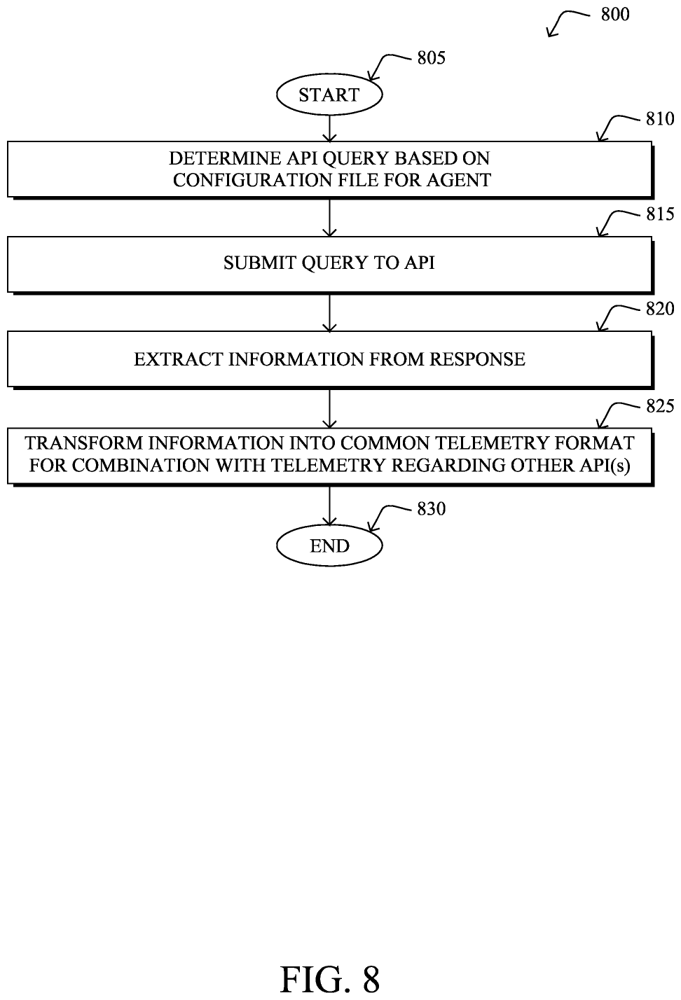

In closing, FIG. 8 illustrates an example simplified procedure for generating observability signals from existing application programming interfaces in accordance with one or more embodiments described herein, particularly from the perspective of either an edge device, a controller, or a general-purpose application programming interface. For example, a non-generic, specifically configured device (e.g., device 200) may perform procedure 800 by executing stored instructions (e.g., process 248, such as an observability signal generation process). The procedure 800 may start at step 805, and continues to step 810, where, as described in greater detail above, device may determine, by executing an agent and based on a configuration file for the agent, a query for particular information from a particular application programming interface from amongst a plurality of application programming interfaces in communication with the agent. In some implementations, the configuration file includes a parameter that controls how the agent queries the particular application programming interface. In some cases, the parameter is indicative of authentication information needed for the agent to query the particular application programming interface. In further cases, the parameter is indicative of a polling interval at which the agent repeatedly submits the query to the particular application programming interface.

At step 815, as detailed above, the device may submit, via the agent, the query for the particular information to the particular application programming interface to receive a response to the query. In some cases, the device may also receive an updated configuration file that configures the agent to submit a new query to a new application programming interface added to the plurality of application programming interfaces in communication with the agent.

At step 820, the device may extract, using the agent, the particular information from the response to the query, based on the configuration file, as described in greater detail above. In various implementations, the configuration file includes a parameter that indicates which of a plurality of extractor modules the agent should use to extract the particular information from the response. In one implementation, the plurality of extractor modules includes at least one of: a JSONPath extractor, an XPath extractor, or a Regular expression extractor. In some instances, the device may also receive an updated configuration file that adds a new extractor module to the plurality of extractor modules.

At step 825, as detailed above, the device may transform, via the agent, the particular information into a common telemetry format for combination with telemetry regarding one or more other application programming interfaces from among the plurality of application programming interfaces. In various implementations, the common telemetry format is OpenTelemetry format. In some cases, the device may also cause, using the agent, the particular information transformed into OpenTelemetry format to be combined with the telemetry regarding the one or more other application programming interfaces into a performance metric for an application that calls the particular application programming interface and the one or more other application programming interfaces.

The procedure 800 may then end in step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for generating observability signals from existing application programming interfaces. In particular, the techniques herein provide a general-purpose API agent that operates utilizing configuration (as opposed to code) to collect observability data from various sources (e.g., API sources, etc.). This can allow for the collection of observability data (e.g., Open Telemetry metrics) from virtually any API and/or SDK without requiring customers, partners, software developers, etc. to write and maintain custom code for every API and/or SDK of interest in a computing environment. Accordingly, aspects of the present disclosure allow for a reduction in costs and/or time, particularly in comparison to previous approaches that generally require writing and maintaining custom code for every API and/or SDK of interest.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by an observability agent,” those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
determining, by a device executing an agent and based on a configuration file for the agent, a query for particular information from a particular application programming interface from amongst a plurality of application programming interfaces in communication with the agent;
submitting, by the device and via the agent, the query for the particular information to the particular application programming interface to receive a response to the query;
extracting, by the device and using the agent, the particular information from the response to the query, based on the configuration file; and
transforming, by the device and via the agent, the particular information into a common telemetry format for combination with telemetry regarding one or more other application programming interfaces from among the plurality of application programming interfaces.

2. The method as in claim 1, wherein the configuration file includes a parameter that indicates which of a plurality of extractor modules the agent should use to extract the particular information from the response.

3. The method as in claim 2, wherein the plurality of extractor modules includes at least one of: a JSONPath extractor, an XPath extractor, or a Regular expression extractor.

4. The method as in claim 2, further comprising:
receiving, at the device, an updated configuration file that adds a new extractor module to the plurality of extractor modules.

5. The method as in claim 1, wherein the common telemetry format is OpenTelemetry format.

6. The method as in claim 5, further comprising:
causing, by the device and using the agent, the particular information transformed into OpenTelemetry format to be combined with the telemetry regarding the one or more other application programming interfaces into a performance metric for an application that calls the particular application programming interface and the one or more other application programming interfaces.

7. The method as in claim 1, wherein the configuration file includes a parameter that controls how the agent queries the particular application programming interface.

8. The method as in claim 7, wherein the parameter is indicative of authentication information needed for the agent to query the particular application programming interface.

9. The method as in claim 7, wherein the parameter is indicative of a polling interval at which the agent repeatedly submits the query to the particular application programming interface.

10. The method as in claim 1, further comprising:
receiving, at the device, an updated configuration file that configures the agent to submit a new query to a new application programming interface added to the plurality of application programming interfaces in communication with the agent.

11. An apparatus, comprising:
one or more network interfaces to communicate with a network;
a processor coupled to the one or more network interfaces and configured to execute one or more processes; and
a memory configured to store a process that is executable by the processor, the process when executed configured to:
determine, by executing an agent and based on a configuration file for the agent, a query for particular information from a particular application programming interface from amongst a plurality of application programming interfaces in communication with the agent;
submit, via the agent, the query for the particular information to the particular application programming interface to receive a response to the query;
extract, using the agent, the particular information from the response to the query, based on the configuration file; and
transform, via the agent, the particular information into a common telemetry format for combination with telemetry regarding one or more other application programming interfaces from among the plurality of application programming interfaces.

12. The apparatus as in claim 11, wherein the configuration file includes a parameter that indicates which of a plurality of extractor modules the agent should use to extract the particular information from the response.

13. The apparatus as in claim 12, wherein the plurality of extractor modules includes at least one of: a JSONPath extractor, an XPath extractor, or a Regular expression extractor.

14. The apparatus as in claim 12, wherein the process when executed is further configured to:
receive an updated configuration file that adds a new extractor module to the plurality of extractor modules.

15. The apparatus as in claim 11, wherein the common telemetry format is OpenTelemetry format.

16. The apparatus as in claim 15, wherein the process when executed is further configured to:
cause, using the agent, the particular information transformed into OpenTelemetry format to be combined with the telemetry regarding the one or more other application programming interfaces into a performance metric for an application that calls the particular application programming interface and the one or more other application programming interfaces.

17. The apparatus as in claim 11, wherein the configuration file includes a parameter that controls how the agent queries the particular application programming interface.

18. The apparatus as in claim 17, wherein the parameter is indicative of authentication information needed for the agent to query the particular application programming interface.

19. The apparatus as in claim 17, wherein the parameter is indicative of a polling interval at which the agent repeatedly submits the query to the particular application programming interface.

20. A tangible, non-transitory, computer-readable medium storing program instructions that cause a device to execute a process comprising:
determining, by an agent of the device and based on a configuration file for the agent, a query for particular information from a particular application programming interface from amongst a plurality of application programming interfaces in communication with the agent;
submitting, by the device and via the agent, the query for the particular information to the particular application programming interface to receive a response to the query;
extracting, by the device and using the agent, the particular information from the response to the query, based on the configuration file; and
transforming, by the device and via the agent, the particular information into a common telemetry format for combination with telemetry regarding one or more other application programming interfaces from among the plurality of application programming interfaces.
